(19) United States
(12) Patent Application Publication
(10) Pub. No.: US 2025/0046498 A1
(43) Pub. Date: Feb. 6, 2025

(54) High-Energy Particulate Resistors

(71) Applicant: Helion Energy, Inc., Everett, WA (US)

(72) Inventors: Brian Campbell, Shoreline, WA (US); Sachin Desai, Everett, WA (US); Dominic Florer, Bellevue, WA (US); David Kirtley, Seattle, WA (US); Christopher James Pihl, Woodinville, WA (US); Ryan Song, North Lakewood, WA (US)

(21) Appl. No.: 18/920,339

(22) Filed: Oct. 18, 2024

Related U.S. Application Data
(63) Continuation of application No. PCT/US2023/065928, filed on Apr. 19, 2023.
(60) Provisional application No. 63/332,454, filed on Apr. 19, 2022.

(51) Int. Cl. H01C 10/12; H01C 10/14; H01C 10/50; H02J 7/00; H02J 7/34

(52) U.S. Cl. CPC H01C 10/12; H01C 10/14; H01C 10/50; H02J 7/007; H02J 7/345; H02J 2207/50

(57) ABSTRACT

A high-energy resistor has a resistive body comprising unbound particulate material. The resistance value of the resistor can be determined in part by a mixing ratio of components in the unbound particulate material and a pressure applied to the particulate material. For a selected mixing ratio, the resistance of the assembled resistor can be adjusted to obtain a selected resistance value with high accuracy by changing pressure on the unbound particulate material. Such adjustment can be made readily by a user before and/or after the resistor is installed in a system. The adjustment can be automated and made during operation of the system to maintain a resistance value precisely.

### CROSS-REFERENCE TO RELATED APPLICATIONS

The present application is a bypass continuation of International Application No. PCT/US2023/065928 filed on Apr. 19, 2023, titled “High-Energy Particulate Resistors,” which claims a priority benefit, under 35 U.S.C. § 119(e), to U.S. provisional application Ser. No. 63/332,454 filed on Apr. 19, 2022, titled “High-Energy Particulate Resistors,” which application is incorporated herein by reference in its entirety.

### BACKGROUND

High-energy, high-power resistors may be used in applications involving high voltages and high currents and/or where high-energy electrical pulses occur or may occur (e.g., in emergency shunting of current, rapid discharging of high-power capacitors, current limiting in high-power circuits, operation of apparatus for plasma confinement or particle acceleration, etc.). Some systems that may use high-energy resistors include systems that produce intense magnetic fields that may be generated with a plurality of current-carrying coils that are driven with high electrical currents and high voltages. Such magnetic fields may be used to confine high-energy particles and/or to accelerate particles or objects to high velocities. In some cases, high magnetic fields may be used to confine a plasma. Other systems that may use high-energy resistors include power generation and transmission systems and systems that perform high-power resistive damping.

### SUMMARY

The described implementations relate to high-energy resistors that can be used in any of the above-mentioned applications. The resistors have resistive volumes, bodies, or cores comprising unbound particulate material instead of a liquid or a solid bound resistive core. The unbound particulate material can include two or more different types of particulate materials and a mixing ratio of the two or more particulate materials and pressure applied to the resistive cores can determine, at least in part, the resistance value of the high-energy resistor. A wide range of resistance values are possible (e.g., from 1 microohm to 100 megaohms or even higher resistance values) depending, in part, on the mixing ratio and applied pressure. Additionally, for a selected mixing ratio, the resistance can be tuned after assembly by adjusting the applied pressure to obtain a desired resistance value to high accuracy. High accuracy can be achieved for very low resistance values and maintained for high-power applications. The tuning of the resistance can provide precise customizability of resistance value to match a target application. In some implementations, multiple resistors can be sized and assembled together to withstand energy levels of at least 100,000 Joules and peak power levels of at least 10,000 watts. The resistors can be used in systems that produce intense magnetic fields, power generation systems, and power transmission systems. The particulate resistors are durable and can maintain an accuracy of resistance value within ±1% or less over the lifetime of the resistor, which can be up to tens of thousands of hours or hundreds of thousands of hours or even longer in high-power or high-energy applications. High-power applications can include peak powers over 50 megawatts per pulse in pulsed operation or over 10 watts in continuous current operation. High-energy applications can include peak energies over 5,000 Joules per pulse in pulsed operation. Some high-power applications can include peak powers up to 1 gigawatt or more per pulse and some high-energy applications can include peak energies up to 50,000 Joules or more per pulse. In some examples, the pulse duration can be from 0.1 millisecond to 1 second with a maximum duty cycle up to 50%. Resistor lifetimes can be longer for power and/or energy levels below these values. Further, if a resistance value of the resistor changes with time, the resistance can be tuned in place to restore the targeted resistance value instead of replacing the resistor. With in-place tuning, the accuracy of resistance value can be maintained even longer.

Some implementations relate to a resistor having an adjustable resistance comprising: a resistive body comprising unbound particulate material; a container to contain the unbound particulate material; a first contact arranged to electrically contact the unbound particulate material from a first end of the container; a second contact arranged to electrically contact the unbound particulate material from a second end of the container; and a clamping assembly to hold the second contact with respect to the first contact and maintain a constant pressure applied by the first contact and the second contact on the unbound particulate material throughout use of the resistor in a circuit. By maintaining a constant pressure on the unbound particulate material, the resistance value of the resistor can be maintained consistently at a selected resistance.

Some implementations relate to a power system comprising a plurality of resistors coupled to a power source and having adjustable resistance values. Each resistor of the plurality of resistors can comprise: a resistive body comprising unbound particulate material; a container to contain the unbound particulate material; a first contact arranged to electrically contact the unbound particulate material from a first end of the container; a second contact arranged to electrically contact the unbound particulate material from a second end of the container; and a clamping assembly to hold the second contact with respect to the first contact and maintain a pressure applied by the first contact and the second contact on the unbound particulate material to provide a constant resistance value throughout use of the resistor during operation of the power system.

Some implementations relate to a method of making an adjustable resistor having a resistive body of unbound particulate material. The method can include acts of: filling a container of a resistor assembly with the unbound particulate material to form the resistive body, wherein the resistor assembly is configured to connect to an electrical circuit; arranging a first contact of the resistor assembly to contact the unbound particulate material at a first location with respect to the container; arranging a second contact of the resistor assembly to contact the unbound particulate material at a second location with respect to the container; and adjusting an adjustment mechanism of the resistor assembly to change an amount of pressure applied by the first contact and the second contact to the unbound particulate material to obtain a pre-selected resistance value for the adjustable resistor.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 depicts a conventional high-energy resistor of the related art.

FIG. 2A depicts, in elevation view, an example of a high-energy particulate resistor.

FIG. 2B depicts, in elevation view, an example of a high-energy particulate resistor having multiple layers with different conductivities in the resistive body.

FIG. 3 depicts, in elevation view, another example of a high-energy particulate resistor with an assembly for adjusting the pressure on the particulate material, distance between contacts, and resistance of the high-energy particulate resistor.

FIG. 4 plots an estimated dependence of resistance on pressure applied to the resistor's unbound particulate material.

FIG. 5 depicts a feedback circuit in which a resistor's resistance value can be tuned automatically during use.

FIG. 6A illustrates an example of a circuit in which one or more particulate resistors can be used.

FIG. 6B illustrates an example of a circuit in which a plurality of particulate resistors can be used.

### DETAILED DESCRIPTION

### I. Solid Core Resistors

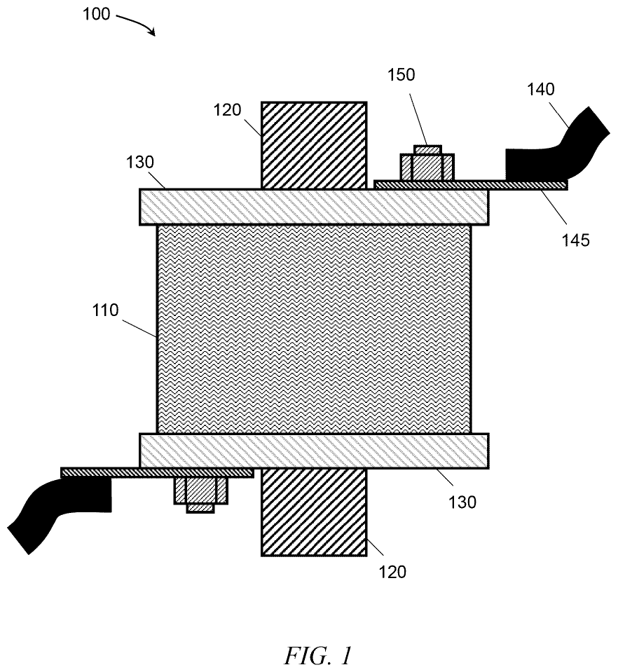

FIG. 1 depicts a high-energy resistor assembly 100 that uses a conventional resistor core 110. Typically, the resistor core 110 is a single solid piece of material (often a matrix of carbon and a ceramic bound together to form a solid core) that is manufactured to have a target resistance value. The resistor core can be in the shape of a disc, rod, tube, or rectangular bar and may or may not have metal contacts 130 attached to the resistor core 110. If contacts 130 are not attached to the resistive core 110, then a clamp 120 may be used to press the contacts 130 against the resistive core. A conductor 140 may attach to each contact 130 via a conductive tab 145 and fastener 150.

Another type of conventional resistor is a so-called “water resistor” or “liquid resistor” that has a liquid core comprising an ionic solution of water and a salt such as copper sulfate, ammonium chloride, sodium thiosulfate, or sodium chloride. Separated electrodes contact the liquid core to form the resistor. The composition of the liquid core and the distance between the electrodes determines the resistance value of the resistor.

The inventors have recognized and appreciated that some high-energy applications (e.g., involving a sequence of pulses, each having energy levels over 5,000 Joules and full-width-half-maximum durations from 0.5 millisecond to 20 milliseconds) can benefit from resistors having very low resistance values (e.g., less than 1 milliohm) and having high resistance accuracy from resistor to resistor (e.g., a standard deviation of resistance value for a plurality of resistors and/or resistance error from a target value that is less than 1%). When multiple resistors (e.g., up to ten, up to one hundred or even more) are used, they may be connected in parallel, series, or some combination thereof. In certain applications, it is desirable that the resistor maintain its resistance value accurately throughout use of the resistor (e.g., during operation of a system in which the resistor is deployed) and over the lifetime of the resistor. Preferably, the change in resistance is negligible (e.g., less than 1%) during operation of a system or circuit in which the resistor is deployed, even though the resistor can carry large currents (operates at high power and/or high energy levels).

The inventors have recognized a problem with conventional ceramic resistors having very low resistance values for high-power and high-energy applications. Solid core, ceramic resistors, having a structure like that described for the resistor of FIG. 1, are prone to fracturing under operating conditions desired by the inventors. Because of the low resistance value and increase in content of conductive material (such as carbon), the solid resistor core 110 becomes structurally weak. Further, the contacts 130 must be applied with sufficient force to reduce contact resistance between the resistor core 110 and contacts 130 to a level that is at or less than the target resistance value. At the same time, if the contacts are not applied with sufficient pressure, arcing between the contacts 130 and the resistor core 110 can occur for some high-voltage applications, which can change the resistance and/or damage the resistor. In some cases, the amount of pressure needed from the contacts 130 to achieve the correct resistance and/or avoid arcing results in breakage of the resistor core 110. Additionally, the resistance values of resistors having a solid resistor core can vary more than an acceptable error tolerance for some high-energy systems at very low resistance values. For example, some high-energy applications may use a large number of high-energy resistors having ostensibly a same resistance value. Differences in resistance values of more than 1% or 2% may not be acceptable and cause system failure. Although liquid resistors may not have the problems associated with contacts, these resistors are undesirable because they require maintenance, suffer from changes in resistance value due to chemical reactions, and the liquid poses a leak hazard in a high-voltage electrical environment.

Further, conventional high-energy solid or liquid-core resistors are high-cost and can have a substantial lead time associated with their fabrication and delivery for custom applications. Developers of high-energy systems or those pursuing research and development applications with high-energy systems may not be able to obtain resistors of different sizes, accurate resistance value, and power capacity on a quick-turnaround basis, hindering their research and development efforts. Moreover, and irrespective of cost, the inventors have not been able to find commercially available resistors capable of operating in their high-energy system that provide a desired resistance accuracy, let alone withstand physical forces in the system without breakage.

### II. A. First Example of a Particulate Resistor

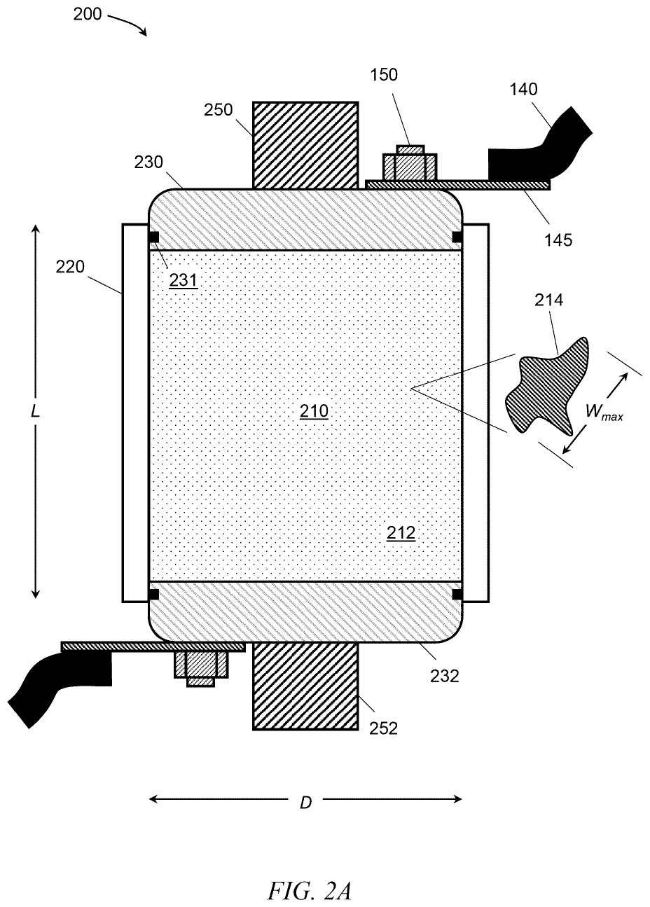

FIG. 2A depicts, in elevation view, an example of an inventive high-energy particulate resistor assembly 200. A cross section of the resistor assembly is illustrated. The resistor assembly comprises an unbound particulate material 212 which forms the resistive body 210. The unbound particulate material is held within a container 220 and fills a volume within the container. A first contact 230 can be applied at a first location with respect to the container to electrically contact the particulate material 212. A second contact 232 can be applied at a second location with respect to the container 220 to electrically contact the particulate material 212 at a different location (e.g., opposite end of the container), thereby providing two terminals or attachment points for two terminals of the resistor assembly 200. A first clamp jaw 250 and a second clamp jaw 252 (electrically insulated from the first clamp jaw) can press against the first contact 230 and the second contact 232 and thereby apply pressure on the unbound particulate material 212.

### II. B. Example Particulate Material

The unbound particulate material 212 does not constitute a single solid piece of material. The unbound particulate material 212 preferably has a texture and consistency resembling desert sand or powder (e.g., it comprises dry, unbound solid particles that can be poured into and out of the container 220). There is no binding agent added or sintering performed to bind the particles together in the container 220. The particles can move with respect to each other when the resistive body 210 is being compressed, while and/or after filling of the container 220, to reach a final working state. In the final working state, the resistive body can be under a fixed, constant pressure and the particles may not move with respect to each other. However, upon removal of the pressure, the unbound particulate material can be poured out of the container (e.g., if it is desired to change the particulate material).

In some cases, the unbound particulate material 212 can be a mixture of two or more classes of particles: conductive (generally understood to be 10⁻⁷ Siemens/meter (S/m) or larger), semiconductive (generally understood to be between 10⁻⁷ S/m and 10⁻¹³ S/m), and/or insulating (generally understood to be 10⁻¹³ S/m and lower). Within each class, there can be one or more types of particles. Example types of conductive particles include, but are not limited to, carbon particles (e.g., carbon powder, graphite powder or particles, fullerenes, carbon nanotubes), aluminum powder, metal particles (e.g., colloidal metal particles, metal filings), and conductive polymer particles (e.g., polypyrrole, polyacetylene, polyaniline). In some cases, graphite powder (available from MSE Supplies LLC of Tucson, Arizona) can be used for the conductive particles. Examples of insulating particle types include, but are not limited to, sand, silica, silicon nitride, alumina, a salt, and boron nitride. In some cases, aluminum oxide blasting media (available from W. W. Grainger, Inc. of Lake Forest, Illinois) can be used for the insulating particles. Boron nitride can be a desirable insulating material for high-power applications because of its high thermal conductivity, which can aid in dissipating heat from the resistive body. Examples of semiconductive particle types include, but are not limited to, undoped or lightly doped semiconductor particles such as undoped or lightly doped silicon or polysilicon particles, undoped or lightly doped germanium particles, etc. A light doping concentration is generally understood to be an impurity concentration of 10¹⁵ cm⁻³ or less, or one impurity atom per 100 billion semiconductor atoms or less. Preferably, the particles have a stable chemical composition (i.e., do not change conductivity over time) and do not chemically interact with and/or degrade components of the resistor assembly.

For some implementations, a resistive body can include metallic particles and lightly doped or undoped semiconductive particles. In some cases, the metallic particles and semiconductive particles may be bound together by heating the mixture to eutectically bond the metal particles to the semiconductive particles and form a solid matrix without an added binder. The eutectically bound matrix may be significantly stronger than a conventional carbon-ceramic bound resistor core. In such an implementation, the resistive body 210 can form a solid and the container 220 may not be used.

When only conductive and insulating particles are used to form the resistive body, a ratio by weight of the conductive particulate material to the insulating particulate material can be (for example) any ratio from 0.5:99.5 to 99.5:0.5, from 15:85 to 35:65 in some cases, from 40:60 to 60:40 in some cases, from 65:35 to 85:15 in some cases. Higher and lower ratios may be possible. When only semiconductive and insulating particles are used to form the resistive body, a ratio by weight of the semiconductive particulate material to the insulating particulate material can be (for example) any ratio from 1:99 to 99:1, from 15:85 to 35:65 in some cases, from 40:60 to 60:40 in some cases, or from 65:35 to 85:15 in some cases. Higher and lower ratios may be possible. When only conductive and semiconductive particles are used to form the resistive body, a ratio by weight of the conductive particulate material to the semiconductive particulate material can be (for example) any ratio from 1:99 to 99:1, from 15:85 to 35:65 in some cases, from 40:60 to 60:40 in some cases, from 65:35 to 85:15 in some cases. Higher and lower ratios may be possible. When conductive, semiconductive, and insulating particles are used, one or two of the particle classes can have, for example, a weight percentage as low as 0.5% of the total weight of the unbound particulate material 212. Further, one of the particle classes may have, for example, a weight percentage as high as 99% of the total weight of the particulate material. Weight percentages between these two limits are possible such that the total of the percentages for the three particle classes does not exceed 100%.

The different types of particulate materials can be well mixed within the resistive body 210 such that the mixture distributes each particulate type essentially homogeneous throughout the resistive body. The mixing ratio of the unbound particulate material determines, at least in part, a resistance of the resistor. Because a wide range of mixing ratios are possible and because a wide range of conductivities are possible for the particles and because a wide range of resistor sizes are possible, a single resistor can be designed to have a resistance value in a range from 1 microohm (10⁻⁶ Ω) or less, to 100 megaohms (10⁸ Ω) or more. However, a particulate resistor can be designed to have a resistance value in any one of several subranges within these values, such as in a range from 10⁻⁶ Ω to 10⁻⁴ Ω, from 10⁻⁴ Ω 10⁻² Ω, from 10⁻² Ω to 1 Ω, from 1 Ω to 10² Ω, from 10² Ω to 10⁴ Ω, or from 10⁴ Ω to 10⁶ Ω, or from 10⁶ Ω to 10⁸ Ω.

The sizes of particles making up the unbound particulate material 212 can vary within the resistive body 210. There can be up to billions or more unbound particles in the resistive body. Each particle 214 (illustrated as a magnified view in FIG. 2A) can have any shape (oblong, spherical, random) with a maximum diameter or maximum transverse dimension Wₘₐₓ. The different types of particulates (conductive, insulating, semi-conductive) can have different shapes from each other or may have similar shapes. The different types of particulates can have different sizes and/or size distributions from each other or may have similar sizes and/or size distributions. In some cases, one or more of the different types of particulates may form aggregates. There can be a distribution of particle sizes in the resistive body 210. For example, the smallest particles in a resistive body 210 may have a maximum transverse dimension Wₘₐₓ measuring down to 25 microns (for example) while the largest particles in the same resistive body can have a maximum transverse dimension Wₘₐₓ measuring up to 800 microns (for example). Particles with sizes between these two values can also be present in the resistive body 210. In some cases, the particle sizes may be within any subrange, or the full range, of values between 25 microns and 800 microns (e.g., from 25 microns to 100 microns, from 50 microns to 200 microns, from 100 microns to 300 microns, from 200 microns to 500 microns, or from 400 microns to 800 microns). In some implementations, smaller particles can be included, for example, having a maximum diameter or maximum transverse dimension less than 25 microns. In some implementations, particles with maximum transverse dimensions greater than 800 microns may be included in the resistive body.

In some implementations, filtering can be used to obtain a more uniform distribution of particle sizes and/or a desired particle size range (e.g., a peak or average size value with a narrow size distribution). The size distribution (full width half maximum points) for filtered particles may be any distribution value in a range from, for example, as broad as ±50% times the peak or average size value (Wₘₐₓ, avg±0.5 Wₘₐₓ, avg) to as narrow as ±10% times the peak or average size value (Wₘₐₓ, avg±0.1 Wₘₐₓ, avg). Filtering can be performed for each of the particle classes. As such, the peak or average size and size distribution can be selected independently and differ for two or more particle classes within a resistive body 210.

When packed into the container 220, there can be voids between the particles such that the resistive body 210 has a porosity. In some cases, the volume of the voids in the resistive body can comprise (for example) up to 6% of the total volume of the resistive body 210 or may have any value in a sub-range from 1% to 80% of the total volume of the resistive body. A total volume of the resistive body is the volume occupied by the particles in the resistive body plus the total volume of the voids.

According to some implementations, the particulate material may be layered into the container 220. The layers can be oriented such that an interfacial surface between layers of different resistivity is essentially perpendicular to the flow of current in the resistive body 210 (as depicted in FIG. 2B). Each layer may contain only one particular particle class of the three classes (conductive, semiconductive, insulating) or can contain a mixture of particles from the three classes. There may be any number of layers in the resistive body 210, and there can be different resistances of the layers. For example and as depicted in FIG. 2B, one or more layers 216 having higher conductivity can be located adjacent to the contacts 230, 232 to reduce contact resistance with lower-conductivity central layer(s) of the resistive body 210 located between the layers 216 of higher conductivity.

### II. C. Use of Liquids in Particulate Resistors

For some applications, insulating oil (e.g., a high-voltage hydrocarbon oil available from Phillips 66 Company), water, or other insulating liquid may be included in the resistive body 210 and permeate throughout the unbound particulate material 212. In some cases, wax may be used and introduced in a molten, liquid state. The insulating liquid may fill interstitial voids between unbound particles and may (for example) comprise up to 70% of the weight of the resistive body 210. Higher weight percentages of the insulating liquid may be possible, such as up to 90%. In some cases, the weight of the insulating liquid may comprise up to 10%, up to 30%, up to 50% of the weight of the resistive body. The insulating liquid can be introduced into the resistive body through at least one hole in the container 220 and/or contact(s) 230, 232 after addition of the unbound particulate material. The insulating liquid can be introduced under pressure and/or using a vacuum and the hole(s) later sealed. Alternatively, an insulating liquid/particle slurry can be mixed and loaded into the container. Excess liquid can be pressed out through a sieve or filter with a mechanical press while installing, or prior to installing, the contacts 230, 232. It can be beneficial to let an oil impregnated resistive body sit idle for a period of time (e.g., at least two days, one week, or longer) to allow the oil to uniformly distribute throughout the resistive body. In some cases, seals 231 can be included to retain the insulating liquid and/or small particles in the container 220. The seals can be formed from an elastic or malleable polymer or polymer composite, such as Teflon® or cross-linked polyethylene composites. When seals are used, particles with maximum transverse dimensions smaller than 25 microns may be included in the resistive body 210.

For some high-voltage applications, the resistor assembly 200 can be immersed in an insulating liquid. In such applications, seals 231 may or may not be used. For example, the seals may not be included if the resistive body 210 is permeated with an insulating liquid and particles are large enough to not leak out between the container/contact interfaces. In some cases, meshes, screens, or baffles may be used as the seals 231 to allow flow of liquid into and out of the resistive body 210 while retaining the particulate material within the resistive body. Inclusion of an insulating liquid in the resistive body and/or immersion of the resistor assembly 200 in an insulating liquid can aid in heat dissipation from the resistive body 210.

### II. D. Container and Contacts for Particulate Resistors

The container 220 (a component of the resistor assembly) can be made from an insulating material, such as a glass, quartz, insulating ceramic, composite material, or plastic. The container can be a tube with a circular or oval cross-section, though other cross-sectional shapes can be used (e.g., square, rectangular, hexagonal, octagonal, polygonal). The contacts 230, 232 can have a same shape as the cross-sectional shape of the container 220 and can be sized to fit inside the container with a close tolerance (e.g., up to 5 mils or approximately 125 microns clearance), to prevent leakage of the particles out of the container 220. Larger tolerances can be used for larger particle sizes (e.g., tolerances up to 250 microns). In some cases, the contacts 230 can be slightly larger than the container's inner diameter (if the container is made from a plastic or composite material) so that the periphery of the contact seals against the container's inner wall when inserted into the container 220.

An overall size of the container 220 and contacts 230 can be determined based upon power or energy levels of an application in which the particulate resistor will be used. Larger sizes can be used for higher power or higher energy applications. For some applications, an inner diameter D (for a cylindrical resistor) or maximum width (for resistors having rectangular or polygonal cross sections) of the container can be from 2 cm to 100 cm, though smaller or larger sizes are possible. A length L of the container 220 can be from 2 cm to 200 cm, though smaller or longer lengths are possible.

The contacts 230, 232 can comprise a conductive metal that comes into physical and electrical contact with the unbound particulate material 212. Example metals include, but are not limited to, aluminum, copper, gold, tungsten, nickel, molybdenum, brass, stainless steel, etc. The contacts 230, 232 can be solid metal. In some implementations, the conductive metal can be coated, attached, or otherwise disposed on another conductive material or an insulating material such as a ceramic, hard plastic, or composite material to form a contact 230, 232.

The contacts 230, 232 can each be configured to attach a conductor 140. For example, a fastener 150 can provide for attaching a conductor or conductive tab 145 that attaches to the cable 140. The fastener can comprise a nut and bolt, threaded stud, press-fit stud, post, clip, tab, connector, etc. The contacts 230, 232 are electrically connected to each other only through the resistive body 210 when not connected to an external circuit.

The contacts can be pressed against the unbound particulate material 212 in the resistive body 210 under high pressure by clamping apparatus. For example, a first clamping jaw 250 can press the first contact 230 against the unbound particulate material 212 and a second clamping jaw 252 can press the second contact 232 against the unbound particulate material 212 at a different location with respect to the container 220. The first contact 230 and first clamping jaw 250 can be on an opposite side of the resistive body 210 than the second contact 232 and second clamping jaw 252, though other arrangements are possible. For example, the resistive body can be clamped and compressed in a first direction that is different (e.g., up to perpendicular) from a second direction that current flows between the first contact 230 and second contact 232. The clamping jaws 250, 252 can be part of an adjustable clamp (e.g., a C clamp to allow precise tuning of the resistance after assembly) or can be fixed in place during assembly after applying an appropriate amount of pressure to the unbound particulate material 212. Alternatively, the clamping jaws can be part of a flexure or spring assembly that applies a desired force on the contacts 230, 232. The flexure or spring assembly can allow separation of the jaws to insert the resistive body 210 and contacts 230, 232 during assembly, followed by release of the jaws 250, 252 to apply a predetermined force on the clamping jaws 250, 252. In some implementations, the jaws 250, 252 can be predetermine distance apart and part of a rigid C-shaped piece. During assembly, the contacts 230, 232 can be pressed against the unbound particulate material 212 in the resistive body enough to force the resistor assembly 200 into place between the clamping jaws 250, 252.

### II. E. Second Example of a Particulate Resistor

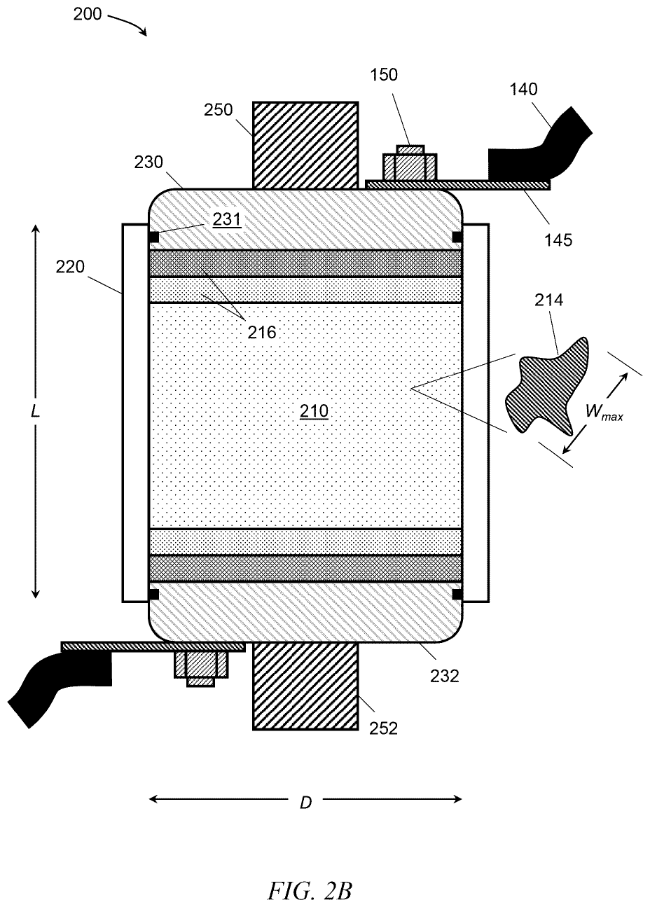

FIG. 3 depicts, in elevation view, another example of a high-energy particulate resistor assembly 202. A cross section of the resistor assembly is illustrated and shows details of one example of a clamping assembly 300. The resistive body 210 can be any resistive body described above in connection with FIG. 2A and FIG. 2B.

The clamping assembly includes a first yoke 302, second yoke 304, bolts 306, nuts 308, and washers 309. The clamping assembly 300 can further include a pressure indicator assembly 340 comprising a pressure bolt 346, pressure nut 348, indicator washer 345, spring washers 344, and force spreader 342. The resistor assembly 202 can further include a first flange 330 and second flange 332, insulator 320, and insulating sleeves 322 for the bolts 306.

The first and second flanges 330, 332 can be formed from a metal (e.g., aluminum) and placed in physical and/or electrical contact with the first and second contacts 230, 232. In some cases, the first and second flanges 330, 332 can be screwed, bolted, registered with pins, or registered with other features to the respective contacts 230, 232. Alternatively, the first and second flanges 330, 332 can be integrally formed from a same piece of metal as the respective contacts 230, 232. The first and second flanges 330, 332 can each include one or more holes 335 (clear and/or threaded) for mounting the resistor assembly 202 in an apparatus and/or for making electrical connection of a conductor 140 to each contact 230, 232. In some cases, the flanges 330, 332 can include heat-dissipative features (e.g., holes, fins, extended size and surface area) to aid in removal of heat from the resistive body 210. Air or another coolant can be used to remove heat from the flanges 330, 332.

The clamping assembly 300 and resistor assembly may be assembled as follows. The force spreader 342 and spring washers 344 can be placed on the pressure bolt 346, which is then inserted through the first yoke 302. The pressure nut 348 and indicator washer 345 can then be placed on the pressure bolt 346. A press or the pressure nut 348 can then be used to apply a selected force to compress the spring washers 344 between the first yoke 302 and force spreader 342 to the selected force. The press may have a force indicator to determine when the selected force has been reached. Alternatively, a force may be determined from an amount of compression of the spring washers 344 (e.g., by measuring a distance between the first yoke 302 and the force spreader 342). The selected force may be determined from prior assembly and testing of a resistor for which a desired resistance was achieved.

If a press is used, once the selected force on the spring washers is reached the pressure nut 348 can be tightened by hand until it holds the indicator washer 345 securely against the first yoke 302. The first yoke 302 with pressure bolt 346 and pressure nut 348 firmly in place can then be removed from the press.

The second contact 232 can be inserted into one end of the container 220, for example, and the unbound particulate material 212 added into the container. The first contact 230 can be inserted into an opposing end of the container 220. The first flange 330 and second flange 332 can be placed against the first contact 230 and second contact 232. The insulator 320 can be installed, which electrically isolates the first flange 330 and first contact 230 from the rest of the resistor assembly.

The second yoke 304 can then be placed and bolted to the first yoke 302 with bolts 306, nuts 308, and washers 309. Lock washers can be used. The nuts 308 can be tightened to clamp the insulator 320, flanges 330, 332, and contacts 230, 232 against the unbound particulate material 212. Bolt insulators 322 can be installed over the bolts 306 to prevent electrical shorting between the bolts 306 and first flange 330 and/or first contact 230. The bolt insulators 322 can be plastic, glass, quartz, or ceramic tubes.

The bolts 306 can then be tightened further until the indicator washer 345 loosens. When the indicator washer loosens such that it can be turned by hand, the selected force (e.g., the force read from a gauge on the press when assembling the first yoke 302, pressure bolt 346, force spreader 342, and spring washers 344) is applied by the contact areas of the first contact 230 and second contact 232 to the unbound particulate material 212.

### II. F. Tuning the Resistance of Particulate Resistors

After assembly of the high-energy resistor, the resistor can be tuned to a desired resistance (as described below). In some cases, at least a portion of the resistor assembly 200, 202 can be encapsulated. For example, some or all of the resistor assembly may be covered with a high-voltage potting resin or an elastomer. An encapsulant that has some flexibility may allow for further tuning of the resistance value after encapsulation.

In some cases, a high-energy resistor can be configured to provide automated or semi-automated adjustment of resistance value. For example, actuators can connect to and rotate bolts 306 or nuts 308 to change a pressure applied to the unbound particulate material 212 and thereby tune the resistance value. Such actuators would rotate the nuts 308, for example, to adjust and fine tune the resistance of the resistor 202.

In some cases, one or more piezoelectric transducers (PZTs) that expand and contract in response to an applied voltage can be used to tune resistance of the resistor 202. The PZT(s) can be positioned between the first flange 330 and the first contact 230, for example, to increase and decrease an amount of pressure applied to the unbound particulate material 212. In some implementations, the actuators or PZTs can be computer controlled.

In some implementations, the actuators or PZTs can be computer controlled. In some cases, automated or semi-automated adjustment of resistance value can be performed in real-time while the resistor is in use in a circuit. Actuators can be controlled in an automated or semi-automated manner using a computer (e.g., a personal computer, laptop, or tablet) or another intelligent controller. Examples of other intelligent controllers include a microprocessor, microcontroller, programmable logic controller, field-programmable gate array, and digital signal controller. The intelligent controller can include and/or be in communication with memory which stores code that can be executed by the intelligent controller.

In some implementations, a surface treatment 312 can be applied to the first contact 230 and second contact 232 of a resistor assembly 200, 202 to improve electrical connectivity and reduce contact resistance between the contacts 230, 232 and the unbound particulate matter 212. In some cases, the surface treatment comprises roughening the surface of the contacts (e.g., abrading, knurling, etching, sand blasting). Alternatively or additionally, a malleable conductive coating can be applied to the surfaces of the contacts 230, 232 that press against the unbound particulate material 212. A malleable coating can comprise a soft metal (e.g., lead, copper, gold, silver). For some implementations, the surface treatment 312 comprises a conductive paste or a conductive polymer that is coated onto the contacting surface of the contacts 230, 232.

To improve pressure uniformity throughout the unbound particulate material 212, several steps of packing can be employed when adding the unbound particulate material to the container 220. For example, one-quarter or some other fraction of the unbound particulate material can be added initially to the container 220 and then pressed into the container against a contact to a desired final pressure. Then, another fraction of the unbound particulate material can be added to the container and pressed again. The steps of adding a portion of the unbound particulate material and pressing can be repeated until all of the unbound particulate material is in the container. Then final assembly of the resistor assembly 202 can proceed. During the steps of pressing, ultrasound or other means for vibrating the container and particulate material 212 can be applied to the container 220 in some cases to assist with packing the unbound particulate material.

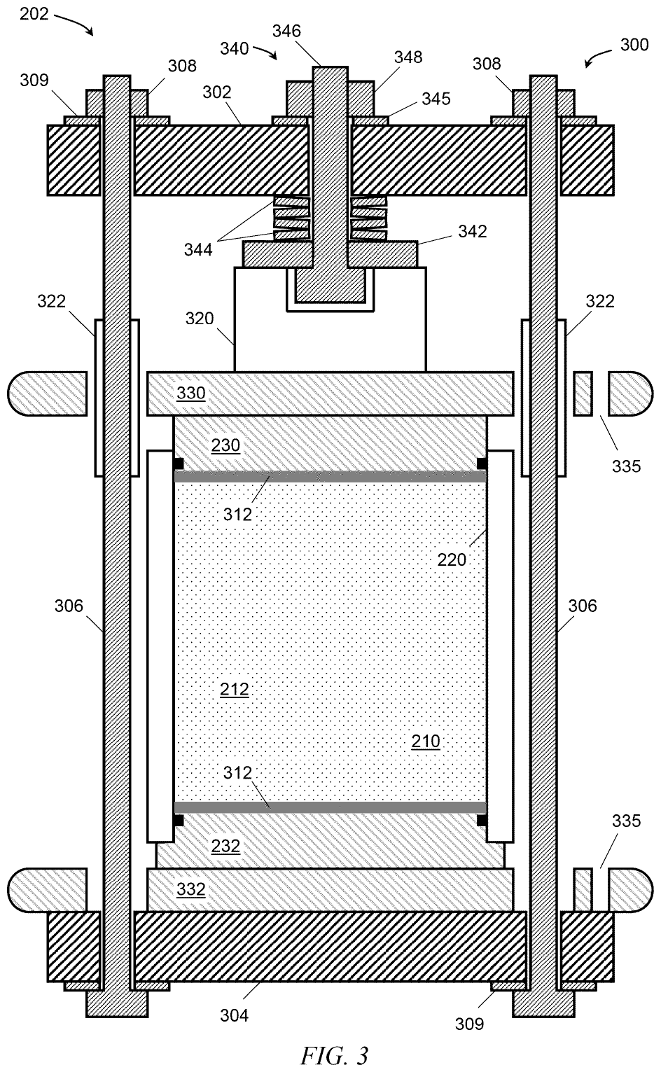

FIG. 4 depicts a change in resistance value of a resistive body 210 (e.g., for a resistor assembly as depicted in FIG. 2A, FIG. 2B, or FIG. 3) as a function of pressure applied to its particulate material 212 by the contacts 230, 232. At low pressures, the resistance value changes rapidly with pressure (e.g., changing by more than a factor of 5 for a doubling of pressure). The resistance at low pressures will reach a high resistance value that is determined by the conductivity of the uncompressed resistive body 210 and/or contact resistance of the first contact 230 and second contact 232 to the resistive body 210. At high pressures, the resistance value can change more slowly with pressure (e.g., up to a factor of 2 with a doubling of pressure). A low resistance value is asymptotically approached and may be determined mainly by the ratio of conductive and/or semi-conductive particulate material to insulating particulate material in the resistive body 210 and a maximum amount of compression achievable with the clamping assembly 300. The plot of FIG. 4 is an example for descriptive purposes only and is not limiting of resistor performance. Although FIG. 4 illustrates a maximum pressure of 600 psi, higher pressures may be used in some implementations (e.g., any value up to 10,000 psi or more) to obtain a desired resistance. The amount of applied pressure that can be applied to a particulate resistor may be determined by strengths of materials used (e.g., tensile strength of bolts, shear limit of bolt or nut threads, strength of container 220, strength of plates) and geometry of the particulate resistor. As may be appreciated, the total resistance for a particulate resistor is determined by the applied pressure, the types and mixing ratio of its particulate components (e.g., ratio of conductive and/or semiconductive particles to insulating particles), conductivity of the conductive and/or semiconductive particles, and the length of the resistive body. Ranges of pressure that may be applied to the particulate material 212 by the contacts 230, 232 to tune the resistor to an operational point may any subrange within a range from 10 psi or lower to 10,000 psi or greater. Example subranges over which a particulate resistor can be tuned can be from 10 psi to 100 psi, from 10 psi to 500 psi, from 10 psi to 1000 psi, from 10 psi to 2000 psi, from 10 psi to 5000 psi, from 100 psi to 500 psi, from 100 psi to 1000 psi, from 100 psi to 2000 psi, from 100 psi to 5000 psi, from 1000 psi to 2000 psi, from 1000 psi to 5000 psi, or from 1000 psi to 10000 psi.

Because in certain configurations the resistance of the resistive body can change in a predictable manner with applied pressure, in certain configurations the resistance can be adjusted or tuned at the factory and/or by a user. For example, a user can tighten or loosen the bolts 306 or nuts 308 for the resistor assembly 202 shown in FIG. 3 while monitoring the resistance until a desired resistance value is obtained. Even if the resistance changes with age of the device, a user can tune the resistance back to the desired value. Tuning can be done in place by disconnecting one or both leads to the resistor that connect(s) to a circuit that includes the resistor. The resistance can then be measured across the resistive body while bolts 306 or nuts 308 are adjusted to change the pressure on the contacts 230, 232. In this manner, accurate resistance values can be obtained and maintained for the high-energy resistors, even for low and very low resistance values. For example, the accuracy can be specified as a tolerance (e.g., ±1% or ±2%) which represents a range of values the resistor can have with respect to a specified value (e.g., 100 microohms±1 microohm). In some cases, resistance tolerance for a particulate resistor can be any value in a range from ±0.01% to ±5% or in a subrange thereof (e.g., a value in a range from ±0.1% to ±1% or from ±0.01% to ±0.1%), though smaller tolerances may be possible. Narrower tolerances and wider tolerances may be achieved in some cases. Further, the accuracy of resistance over the lifetime of the resistor can be improved with tuning of the resistance value (e.g., tuned as the resistor ages). For example, the accuracy of the resistance value over the lifetime of the particulate resistor can be any value in a range from ±0.01% to ±5% or in a subrange thereof (e.g., a value in a range from ±0.1% to ±1% or from ±0.01% to ±0.1%), though greater accuracy may be possible. The lifetime of the resistor can be up to hundreds of hours, up to thousands of hours, up to tens of thousands of hours, hundreds of thousands of hours, or even longer.

The tuning range of a particulate resistor can be large and determined, at least in part, by choice of particulate material and by a range of pressure applied to its particulate material 212 by the contacts 230, 232. The tuning range can depend upon the conductivity of particulates used to form the resistive body. For example, a particulate resistor designed to have a very low resistance value (less than 1 ohm) at a maximum applied pressure may have a larger tuning range than a particulate resistor designed to have a very high resistance value (over 100 kiloohms). The tuning range of a particulate resistor can be a factor in a range from 0.9 to 10⁻⁴. A tuning range of a factor of 0.1 means that a particulate resistor can be tuned from a first resistance value R to a second resistance value of 0.1 R: for example, from a value of 10,000 ohms to 1,000 ohms. However, a particulate resistor can have a tuning factor in any one of several subranges within these values, such as in a range from 0.9 to 0.1, from 0.9 to 10⁻², from 0.9 to 10⁻³, or from 0.9 to 10⁻⁴.

In some cases, the tuning range can depend upon the application. For example, in high-power and/or high-voltage applications, a high level of pressure may be applied to the contacts 230, 232 at all times to reduce the chance of arcing in the resistor. As such, the tuning range of resistors in such applications may be limited to lower factors (e.g., a factor in a range from 0.9 to 0.1). Resistance values in such applications can be determined primarily by the composition of the particulate material 212 in the resistive body 210.

In some implementations, a resistor may be conditioned during a tuning process. For example, the resistor can be tuned to a selected resistance value as described above. Then in a conditioning step, current can be driven through the resistor to emulate an intended use (e.g., a high-power and/or high-voltage application). Subsequently, the resistance value can be checked and retuned to the selected resistance value if a change in resistance value occurs from the conditioning step.

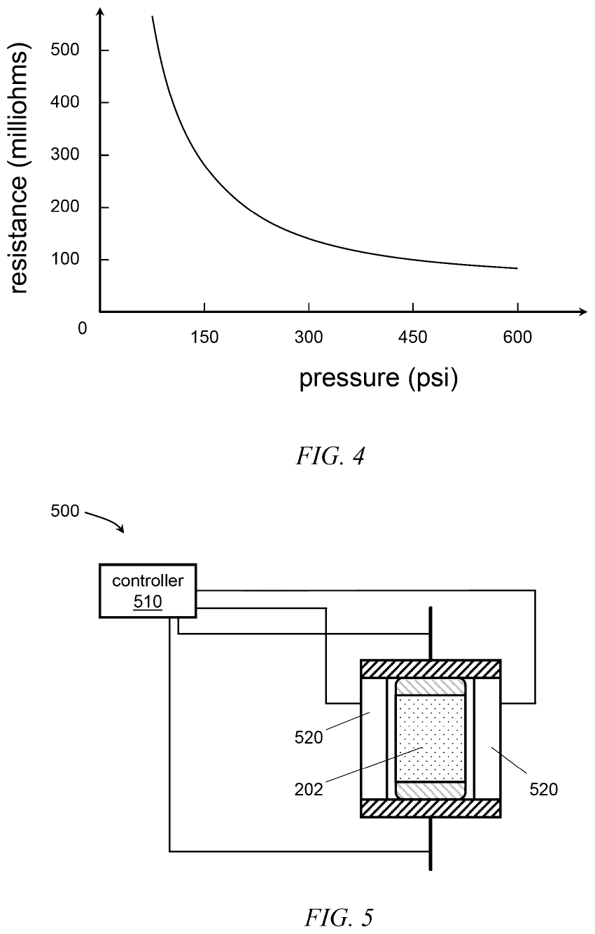

FIG. 5 depicts a feedback circuit in which a resistor's resistance value can be tuned automatically during use. A controller 510 (such as an intelligent controller described above) can receive at least one signal indicative of the resistance of the particulate resistor 202. The signal(s) may comprise voltage sensed on either side of the resistor 202, for example, and current passing through the resistor. In some cases, resistance value can be sensed indirectly from a temperature of the resistor after a known amount of current passes through the resistor. Based on the received signals, the controller 510 can determine a resistance of the resistor 202. The controller 510 can output one or more signals to drive one or more actuators 520 that control an amount of pressure applied to the particulate material in the resistor 202. In response to determining a current resistance of the resistor 202 from the received signals, the controller 510 can output signals to the actuator(s) 520 to increase or decrease an amount of pressure applied to the particulate material to obtain and maintain a selected resistance value. In some cases, the controller can be programmed to reduce any error between received signal values (indicative of a sensed resistance value) and target signal values (indicative of a selected resistance value).

### II. G. Example Circuits and Applications for Particulate Resistors

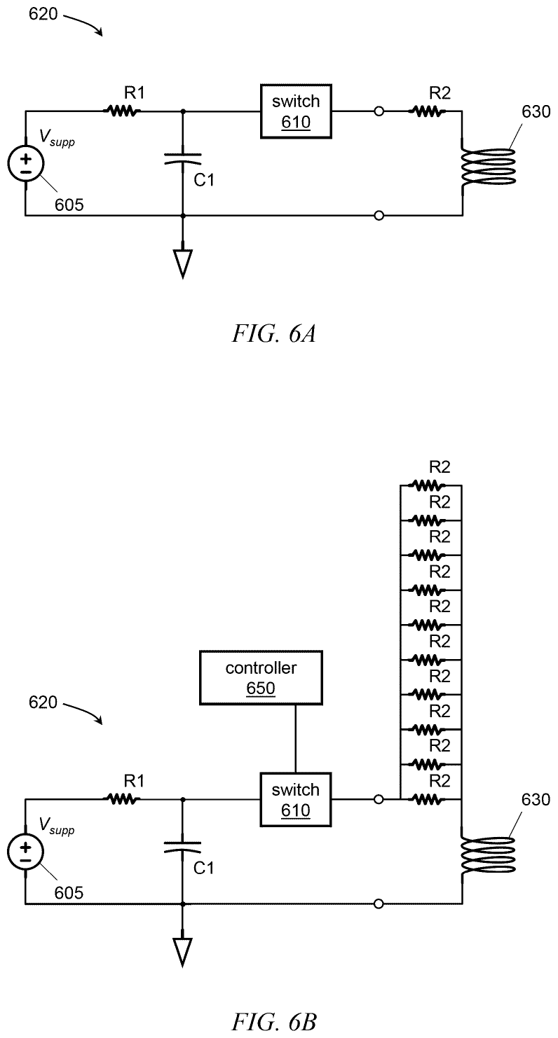

FIG. 6A depicts an example of a supply circuit 620 that can include resistors R1, R2 implemented as any one of the above-described inventive resistor embodiments. The supply circuit 620 can be used to drive current through a load, such as an electromagnetic coil 630. The supply circuit 620 can include a capacitor C1 that can be used to store a large amount of energy. The capacitor C1 can be charged to a high energy state by a current source or voltage source 605, which may or may not be part of the supply circuit. The particulate resistor R1 can be used to control a charging rate of the capacitor C1. A second particulate resistor R2 can be used to control a discharge rate from the capacitor C1 and behavior of the current pulse applied to the coil 630 (e.g., damping of oscillations). Resistors R1 and/or R2 can be implemented as a plurality of resistors (of any one of the above-described inventive embodiments) connected in parallel. The voltage source 605 and capacitor C1 can connect in series with a switch 610 that closes to apply voltage Vₛᵤₚₚ to the coil 630 when switched from an open state to a closed state. When the switch is in an open state, the capacitor C1 can be charged. Examples of such supply circuits in which the particulate resistors can be used are described in international application PCT/US2022/032277, titled “Energy Recovery in Electrical Systems,” filed Jun. 3, 2022, and in international application PCT/US2022/033319, titled “High-Speed Switching Apparatus for Electromagnetic Coils,” filed Jun. 11, 2022, both of which applications are incorporated by reference herein in their entirety.

Other circuits that can include particulate resistors of the above-described embodiments include, but are not limited to, circuits supporting high voltages (e.g., in 10,000 volts or more), high currents (e.g., 1,000 amps or more) and/or high-energy electrical pulses (e.g., 5,000 Joules per pulse or more). A circuit containing a particulate resistor may perform emergency shunting of high currents, discharging of high-power capacitors, current limiting in high-power circuits or high-power resistive damping. Such circuits can be used in systems that produce intense magnetic fields (e.g., 1 Tesla or more) where the fields can be generated with a plurality of current-carrying coils that are driven with high electrical currents and high voltages. The circuits can also be used in high-power generation and transmission systems.

Although the above implementations describe single resistors that can be made to withstand high voltages, high power, high currents, and/or high energy levels, the particulate resistors can be made smaller in size for some applications. For example, some applications may not involve high voltages, high power, high currents, and/or high energy levels and therefore the resistors can be sized to withstand less severe operating conditions.

Alternatively, a plurality of resistors (e.g., tens, hundreds, or more) can be used in a high-voltage, high-power, high-current, and/or high-energy-level environment to distribute the loading on each particulate resistor. FIG. 6B depicts another example of a supply circuit 620 that can include a plurality of resistors R2 (implemented as any one of the above-described inventive resistor embodiments) that are connected in parallel to distribute the loading experienced by each particulate resistor. A controller 650 (e.g., a microprocessor or microcontroller) may be used to activate the switch 610. In such cases, each particulate resistor can be sized to withstand less severe operating conditions. For example, five particulate resistors, each sized to withstand up to 1,000 Joule pulses, connected in parallel can be used in an application involving electrical pulses having up to 4,500 Joules in each pulse. The pulse duration may be as short as 0.1 millisecond and as long as one second FWHM with a maximum duty cycle up to 50%. Accordingly, multiple particulate resistors can be sized and assembled to handle pulses having energy levels (for example) from 200 J to 1 kJ in some cases, from 1 kJ to 10 kJ in some cases, and yet from 10 kJ to 100 kJ in some cases. Shorter pulse durations may also be possible and other ranges between 200 J and 100 kJ are possible. Smaller energy levels are also possible and higher energy levels are possible depending on the number of resistors used. The particulate resistors described above can be used in circuits operating at low or medium energy, power, and/or voltage levels. For example, a single particulate resistor can be sized to withstand an energy level up to 0.25 J, up to 0.5 J, up to 1 J, up to 2 J, up to 5 J, up to 10 J, up to 50 J, up to 100 J, up to 200 J, up to 500 J, up to 1,000 J per pulse, up to 5,000 J per pulse, up to 10,000 J per pulse, up to 50,000 J per pulse, up to 100,000 J per pulse, up to 500,000 J per pulse. Depending on the pulse duration, the peak power level sustained by a particulate resistor designed to withstand the above example energy levels can be a value from 0.25 Watt (0.25 J, 1 second pulse duration), to 1,000 megawatts (500,000 J, 0.5 millisecond pulse duration) or greater.

Under continuous current operating conditions, a maximum power that can be

continuously dissipated by a single particulate resistor can depend on the resistor geometry, materials used, and heat sinking of the resistor. A single resistor may be able to sustain continuous power levels of up to up to 0.25 watt, up to 0.5 watt, 1 watt, up to 10 watts, up to 50 watts, or up to 100 watts or greater.

In some of the above high-energy and high-power applications, such as those described in international application PCT/US2022/033319 referenced above, it may be preferable that resistance values remain essentially constant throughout the operable lifetime of the resistor in the circuit. For example, a change in resistance by one or more of the resistors in the circuit may cause failed operation of (and possibly damage to) the system in which the resistor is used. In some cases, the resistance values of a plurality of resistors should remain essentially constant (e.g., within 1% to 2% or less of an initial resistance value) during operation of the system and not be allowed to change by more than this amount during operation of the system.

An aspect of the above-described particulate resistors is that resistance values of one or more system resistors can be tuned (to within a predetermined accuracy) during or after assembly of the system to assure that resistance values satisfy strict specifications for the system. In some cases, a system may have a plurality of resistors with different resistance values and a plurality of resistors having the same resistance values, all specified to be within narrow tolerances (e.g., within 1% to 2% or less of specified resistance values). Resistance values can be checked, and tuned if needed, prior to operation of the system. During system downtime, the resistance values can be checked and retuned, if necessary, to maintain resistance values within specifications for the system.

Various configurations of particulate resistors and methods of making particulate resistors are possible. Some example configurations and methods are listed below.
(1) A resistor having an adjustable resistance comprising: a resistive body comprising unbound particulate material; a container to contain the unbound particulate material; a first contact arranged to electrically contact the unbound particulate material from a first end of the container; a second contact arranged to electrically contact the unbound particulate material from a second end of the container; and a clamping assembly to hold the second contact with respect to the first contact and maintain a constant pressure applied by the first contact and the second contact on the unbound particulate material throughout use of the resistor in a circuit.
(2) The resistor of configuration (1), further comprising at least one adjustment mechanism to adjust a distance between the first contact and the second contact to obtain a value of resistance that is within 2% of a selected resistance value.
(3) The resistor of configuration (1) or (2), wherein the resistor is sized to withstand repeated energy pulses each having an energy up to 5,000 joules.
(4) The resistor of any one of configurations (1) through (3), wherein the unbound particulate material comprises: an insulating particulate material; and a conductive particulate material distributed throughout the insulating particulate material.
(5) The resistor of configuration (4), wherein the insulating particulate material comprises sand.
(6) The resistor of configuration (4), wherein the insulating particulate material comprises silica, silicon nitride, alumina, boron nitride, or some combination thereof.
(7) The resistor of configuration (4), wherein the conductive particulate material comprises carbon.
(8) The resistor of configuration (4), wherein the conductive particulate material comprises aluminum powder, metal particles, graphite, a conductive salt, or some combination thereof.
(9) The resistor of any one of configurations (1) through (8), wherein the resistive body does not contain a liquid.
(10) The resistor of any one of configurations (1) through (8), further comprising an insulating oil permeating the unbound particulate material.
(11) The resistor of any one of configurations (1) through (10), further comprising a surface treatment applied to a surface of the first contact to physically contact the unbound particulate material.
(12) The resistor of configuration (11), wherein the surface treatment comprises a roughening of the surface.
(13) The resistor of configuration (11), wherein the surface treatment comprises a metal coating applied to the surface.
(14) The resistor of configuration (11), wherein the surface treatment comprises a conductive paste applied to the surface.
(15) The resistor of any one of configurations (1) through (14), further comprising at least one adjustment mechanism to adjust a distance between the first contact and the second contact to obtain a selected value of resistance for the resistor.
(16) The resistor of configuration (15), wherein the at least one adjustment mechanism is configured to be adjusted by a user of the resistor.
(17) The resistor of configuration (15), wherein the at least one adjustment mechanism is configured to be adjusted by an automated or semi-automated actuator.
(18) The resistor of any one of configurations (1) through (17), wherein the clamping assembly comprises: a first yoke coupled to the first contact; a second yoke coupled to the second contact; an insulator between the first yoke and the first contact to electrically isolate at least the first yoke from the first contact; and two or more bolts with two or more nuts connecting the first yoke and the second yoke, wherein tightening of the two or more nuts increases a force applied by the first yoke and the second yoke to the first contact and the second contact.
(19) The resistor of configuration (18), further comprising a pressure indicator assembly coupled between the first yoke and the first contact or between the second yoke and the second contact.
(20) The resistor of configuration (19), wherein the pressure indicator assembly comprises: a pressure bolt passing through the first yoke or the second yoke; one or more spring washers on the pressure bolt and located between the first yoke and the second yoke; an indicator washer on the pressure bolt and located on an opposite side of the first yoke or the second yoke than the one or more spring washers; and a pressure nut to tighten the indicator washer against the first yoke or the second yoke.
(21) The resistor of configuration (18), further comprising a flange coupled to the first contact or the second contact, the flange having one or more holes for making an electrical connection to the resistor and/or for mounting the resistor.
(22) A power system comprising: a plurality of resistors coupled to a power source and having adjustable resistance values, each resistor of the plurality of resistors comprising: a resistive body comprising unbound particulate material; a container to contain the unbound particulate material; a first contact arranged to electrically contact the unbound particulate material from a first end of the container; a second contact arranged to electrically contact the unbound particulate material from a second end of the container; and a clamping assembly to hold the second contact with respect to the first contact and maintain a pressure applied by the first contact and the second contact on the unbound particulate material to provide a resistance value that is constant to within 2% throughout use of the resistor during operation of the power system.
(23) The power system of configuration (22), wherein the resistors of the plurality of resistors are adjusted to have a same resistance value to within 2%.
(24) The power system of configuration (22) or (23), wherein each resistor of the plurality of resistors is sized to withstand repeated energy pulses each having an energy up to 5,000 joules.
(25) The power system of any one of configurations (22) through (24), wherein the unbound particulate material comprises: an insulating particulate material; and a conductive particulate material distributed throughout the insulating particulate material.
(26) The power system of configuration (25), wherein the insulating particulate material comprises sand.
(27) The power system of configuration (25), wherein the insulating particulate material comprises silica, silicon nitride, alumina, boron nitride, or some combination thereof.
(28) The power system of configuration (25), wherein the conductive particulate material comprises carbon.
(29) The power system of configuration (25), wherein the conductive particulate material comprises aluminum powder, metal particles, graphite, a conductive salt, or some combination thereof.
(30) The power system of any one of configurations (22) through (29), wherein the resistive body does not contain a liquid.
(31) The power system of any one of configurations (22) through (29), further comprising an insulating oil permeating the unbound particulate material.
(32) The power system of any one of configurations (22) through (31), further comprising for each resistor of the plurality of resistors a surface treatment applied to a surface of the first contact to physically contact the unbound particulate material.
(33) The power system of configuration (32), wherein the surface treatment comprises a roughening of the surface.
(34) The power system of configuration (32), wherein the surface treatment comprises a metal coating applied to the surface.
(35) The power system of configuration (32), wherein the surface treatment comprises a conductive paste applied to the surface.
(36) The power system of any one of configurations (22) through (35), further comprising for each resistor of the plurality of resistors at least one adjustment mechanism to adjust a distance between the first contact and the second contact to obtain a selected value of resistance for the resistor.
(37) The power system of configuration (36), wherein the at least one adjustment mechanism is configured to be adjusted by a user of the resistor.
(38) The power system of configuration (36), wherein the at least one adjustment mechanism is configured to be adjusted by an automated or semi-automated actuator.
(39) The power system of any one of configurations (22) through (38), wherein the clamping assembly comprises: a first yoke coupled to the first contact; a second yoke coupled to the second contact; an insulator between the first yoke and the first contact to electrically isolate at least the first yoke from the first contact; and two or more bolts with two or more nuts connecting the first yoke and the second yoke, wherein tightening of the two or more nuts increases a force applied by the first yoke and the second yoke to the first contact and the second contact.
(40) The power system of configuration (39), further comprising for each resistor of the plurality of resistors a pressure indicator assembly coupled between the first yoke and the first contact or between the second yoke and the second contact.
(41) The power system of configuration (40), wherein the pressure indicator assembly comprises: a pressure bolt passing through the first yoke or the second yoke; one or more spring washers on the pressure bolt and located between the first yoke and the second yoke; an indicator washer on the pressure bolt and located on an opposite side of the first yoke or the second yoke than the one or more spring washers; and a pressure nut to tighten the indicator washer against the first yoke or the second yoke.
(42) The power system of any one of configurations (39) through (41), further comprising for each resistor of the plurality of resistors a flange coupled to the first contact or the second contact, the flange having one or more holes for making an electrical connection to the resistor and/or for mounting the resistor.
(43) A method of making an adjustable resistor having a resistive body of unbound particulate material, the method comprising: filling a container of a resistor assembly with the unbound particulate material to form the resistive body, wherein the resistor assembly is configured to connect to an electrical circuit; arranging a first contact of the resistor assembly to contact the unbound particulate material at a first location with respect to the container; arranging a second contact of the resistor assembly to contact the unbound particulate material at a second location with respect to the container; and adjusting an adjustment mechanism of the resistor assembly to change an amount of pressure applied by the first contact and the second contact to the unbound particulate material to obtain a selected resistance value for the adjustable resistor.
(44) The method of (43), wherein adjusting the adjustment mechanism continues until the selected resistance value is within 2% of a target resistance value.
(45) The method of (43) or (44), wherein filling the container comprises: filling a first portion of the container with a first portion of the unbound particulate material; applying pressure to the unbound particulate material to pack the first portion of the unbound particulate material into the container; filling a second portion of the container with a second portion of the unbound particulate material; and applying pressure to the unbound particulate material to pack the second portion of the unbound particulate material into the container.
(46) The method of any one of (43) through (45), further comprising impregnating the unbound particulate material with an insulating liquid.

### III. CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A resistor (200, 202) having an adjustable resistance comprising:
a resistive body (210) comprising unbound particulate material (214);
a container (220) to contain the unbound particulate material;
a first contact (230) arranged to electrically contact the unbound particulate material from a first end of the container;
a second contact (232) arranged to electrically contact the unbound particulate material from a second end of the container; and
a clamping assembly (300) to hold the second contact with respect to the first contact and maintain a constant pressure applied by the first contact and the second contact on the unbound particulate material throughout use of the resistor in a circuit.

2. The resistor of claim 1, further comprising:
at least one adjustment mechanism to adjust a distance between the first contact and the second contact to obtain a value of resistance that is within 2% of a selected resistance value.

3. The resistor of claim 2, wherein the resistor is sized to withstand repeated energy pulses each having an energy up to 5,000 joules.

4. The resistor of any one of claims 1 through 3, wherein the unbound particulate material comprises:
an insulating particulate material; and
a conductive particulate material distributed throughout the insulating particulate material.

5. The resistor of claim 4, wherein the insulating particulate material comprises sand.

6. The resistor of claim 4, wherein the insulating particulate material comprises silica, silicon nitride, alumina, boron nitride, or some combination thereof.

7. The resistor of claim 4, wherein the conductive particulate material comprises carbon.

8. The resistor of claim 4, wherein the conductive particulate material comprises aluminum powder, metal particles, graphite, a conductive salt, or some combination thereof.

9. The resistor of any one of claims 1 through 3, wherein the resistive body does not contain a liquid.

10. The resistor of any one of claims 1 through 3, further comprising an insulating oil permeating the unbound particulate material.

11. The resistor of any one of claims 1 through 3, further comprising:
a surface treatment applied to a surface of the first contact to physically contact the unbound particulate material.

12. The resistor of claim 11, wherein the surface treatment comprises a roughening of the surface.

13. The resistor of claim 11, wherein the surface treatment comprises a metal coating applied to the surface.

14. The resistor of claim 11, wherein the surface treatment comprises a conductive paste applied to the surface.

15. The resistor of any one of claims 1 through 3, further comprising:
at least one adjustment mechanism to adjust a distance between the first contact and the second contact to obtain a selected value of resistance for the resistor.

16. The resistor of claim 15, wherein the at least one adjustment mechanism is configured to be adjusted by a user of the resistor.

17. The resistor of claim 15, wherein the at least one adjustment mechanism is configured to be adjusted by an automated or semi-automated actuator.

18. The resistor of any one of claims 1 through 3, wherein the clamping assembly comprises:
a first yoke coupled to the first contact;
a second yoke coupled to the second contact;
an insulator between the first yoke and the first contact to electrically isolate at least the first yoke from the first contact; and
two or more bolts with two or more nuts connecting the first yoke and the second yoke, wherein tightening of the two or more nuts increases a force applied by the first yoke and the second yoke to the first contact and the second contact.

19. The resistor of claim 18, further comprising:
a pressure indicator assembly coupled between the first yoke and the first contact or between the second yoke and the second contact.

20. The resistor of claim 19, wherein the pressure indicator assembly comprises:
a pressure bolt passing through the first yoke or the second yoke;
one or more spring washers on the pressure bolt and located between the first yoke and the second yoke;
an indicator washer on the pressure bolt and located on an opposite side of the first yoke or the second yoke than the one or more spring washers; and
a pressure nut to tighten the indicator washer against the first yoke or the second yoke.

21. The resistor of claim 18, further comprising:
a flange coupled to the first contact or the second contact, the flange having one or more holes for making an electrical connection to the resistor and/or for mounting the resistor.

22. A power system comprising:
a plurality of resistors coupled to a power source and having adjustable resistance values, each resistor of the plurality of resistors comprising:
a resistive body comprising unbound particulate material;
a container to contain the unbound particulate material;
a first contact arranged to electrically contact the unbound particulate material from a first end of the container;
a second contact arranged to electrically contact the unbound particulate material from a second end of the container; and
a clamping assembly to hold the second contact with respect to the first contact and maintain a pressure applied by the first contact and the second contact on the unbound particulate material to provide a resistance value that is constant to within 2% throughout use of the resistor during operation of the power system.

23. The power system of claim 22, wherein the resistors of the plurality of resistors are adjusted to have a same resistance value to within 2%.

24. The power system of claim 22, wherein each resistor of the plurality of resistors is sized to withstand repeated energy pulses each having an energy up to 5,000 joules.

25. The power system of any one of claims 22 through 24, wherein the unbound particulate material comprises:
an insulating particulate material; and
a conductive particulate material distributed throughout the insulating particulate material.

26. The power system of claim 25, wherein the insulating particulate material comprises sand.

27. The power system of claim 25, wherein the insulating particulate material comprises silica, silicon nitride, alumina, boron nitride, or some combination thereof.

28. The power system of claim 25, wherein the conductive particulate material comprises carbon.

29. The power system of claim 25, wherein the conductive particulate material comprises aluminum powder, metal particles, graphite, a conductive salt, or some combination thereof.

30. The power system of any one of claims 22 through 24, wherein the resistive body does not contain a liquid.

31. The power system of any one of claims 22 through 24, further comprising an insulating oil permeating the unbound particulate material.

32. The power system of any one of claims 22 through 24, further comprising for each resistor of the plurality of resistors:
a surface treatment applied to a surface of the first contact to physically contact the unbound particulate material.

33. The power system of claim 32, wherein the surface treatment comprises a roughening of the surface.

34. The power system of claim 32, wherein the surface treatment comprises a metal coating applied to the surface.

35. The power system of claim 32, wherein the surface treatment comprises a conductive paste applied to the surface.

36. The power system of any one of claims 22 through 24, further comprising for each resistor of the plurality of resistors:
at least one adjustment mechanism to adjust a distance between the first contact and the second contact to obtain a selected value of resistance for the resistor.

37. The power system of claim 36, wherein the at least one adjustment mechanism is configured to be adjusted by a user of the resistor.

38. The power system of claim 36, wherein the at least one adjustment mechanism is configured to be adjusted by an automated or semi-automated actuator.

39. The power system of any one of claims 22 through 24, wherein the clamping assembly comprises:
a first yoke coupled to the first contact;
a second yoke coupled to the second contact;
an insulator between the first yoke and the first contact to electrically isolate at least the first yoke from the first contact; and
two or more bolts with two or more nuts connecting the first yoke and the second yoke, wherein tightening of the two or more nuts increases a force applied by the first yoke and the second yoke to the first contact and the second contact.

40. The power system of claim 39, further comprising for each resistor of the plurality of resistors:
a pressure indicator assembly coupled between the first yoke and the first contact or between the second yoke and the second contact.

41. The power system of claim 40, wherein the pressure indicator assembly comprises:
a pressure bolt passing through the first yoke or the second yoke;
one or more spring washers on the pressure bolt and located between the first yoke and the second yoke;
an indicator washer on the pressure bolt and located on an opposite side of the first yoke or the second yoke than the one or more spring washers; and
a pressure nut to tighten the indicator washer against the first yoke or the second yoke.

42. The power system of claim 39, further comprising for each resistor of the plurality of resistors:
a flange coupled to the first contact or the second contact, the flange having one or more holes for making an electrical connection to the resistor and/or for mounting the resistor.

43. A method of making an adjustable resistor having a resistive body of unbound particulate material, the method comprising:
filling a container of a resistor assembly with the unbound particulate material to form the resistive body, wherein the resistor assembly is configured to connect to an electrical circuit;
arranging a first contact of the resistor assembly to contact the unbound particulate material at a first location with respect to the container;
arranging a second contact of the resistor assembly to contact the unbound particulate material at a second location with respect to the container; and
adjusting an adjustment mechanism of the resistor assembly to change an amount of pressure applied by the first contact and the second contact to the unbound particulate material to obtain a selected resistance value for the adjustable resistor.

44. The method of claim 43, wherein adjusting the adjustment mechanism continues until the selected resistance value is within 2% of a target resistance value.

45. The method of claim 43 or claim 44, wherein filling the container comprises:
filling a first portion of the container with a first portion of the unbound particulate material;
applying pressure to the unbound particulate material to pack the first portion of the unbound particulate material into the container;
filling a second portion of the container with a second portion of the unbound particulate material; and
applying pressure to the unbound particulate material to pack the second portion of the unbound particulate material into the container.

46. The method of claim 43 or claim 44, further comprising impregnating the unbound particulate material with an insulating liquid.
